(19) United States
(12) Patent Application Publication
(10) Pub. No.: US 2009/0259367 A1
(43) Pub. Date: Oct. 15, 2009

(54) METHOD FOR CONTROLLING MOTOR-DRIVEN POWER STEERING SYSTEM

(75) Inventor: Hae Ryong Choi, Seoul (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/276,643

(22) Filed: Nov. 24, 2008

(30) Foreign Application Priority Data
Apr. 15, 2008 (KR) 10-2007-0130544

(51) Int. Cl. B62D 6/00

(52) U.S. Cl. 701/42

(57) ABSTRACT

A method for controlling a motor-driven power steering system, in which a target torque value of a motor is calculated through conducting torque boost control, returning force control and damping control by receiving a steering torque, a steering angle, a steering angular velocity and a vehicle speed, current motor current is sensed, proportional integral control is conducted for the current motor current, a pulse width modulation signal for compensating for an over/under voltage in comparison with the target torque value is generated, and a final motor torque is controlled. The proportional integral control is added with motor speed-responsive control by a proportional constant (α) that varies depending upon the motor speed, which is sensed in real time.

### CROSS-REFERENCE TO RELATED APPLICATIONS

This application claims under 35 U.S.C. §119(a) priority to Korean Application No. 10-2007-0130544, filed on Dec. 13, 2007, the disclosure of which is incorporated herein by reference in its entirety.

### BACKGROUND

1. Technical Field

The present invention relates to a method for controlling a motor-driven power steering system for a vehicle and, more particularly, to a method for controlling a motor-driven power steering system, which can compensate for an increase in inertia moment caused by an increase in the gear ratio between the worm and the worm wheel constituting a reduction gear box in a motor-driven power steering system for a vehicle.

2. Background Art

A motor-driven power steering system (MDPS) represents an apparatus which controls the steering force of a steering wheel depending upon a vehicle speed, using the power of a motor. More specifically, the motor-driven power steering system decreases the steering force of the steering wheel while parking or traveling at a low speed and increases the steering force of the steering wheel while traveling at a high speed, to provide high speed running stability and allow a steering operation to be quickly implemented in an emergency situation, so that optimal driving conditions can be provided to the driver.

FIG. 1 illustrates a conventional motor-driven power steering system. This system comprises a steering wheel 1 which is manipulated by a driver, a steering column 2 which is connected to the steering wheel 1 and is rotated by the driver to conform to the driver's steering direction, a controller 3 which is installed on an end portion of the steering column 2, controls the entire motor-driven power steering system, and, in particular, outputs final current for controlling a motor torque, a motor 4 which is mounted to an end portion of the steering column 2 and is actuated by the final current outputted from the controller 3, a reduction gear box 5 which adjusts the rotation speed of the motor 4, a torque sensor 6 which senses the steering torque of the steering wheel 1, a universal joint 7 which transmits the rotation force of the motor 4 to wheels, and a gear box 8. In addition, a vehicle speed sensor, a steering angle sensor, a steering angular velocity sensor, etc. are mounted to transmit their sensing results to the controller 3.

Compared with an ordinary hydraulic power steering system, the motor-driven power steering system constructed as described above provides various advantages in that fuel economy is improved and maintenance costs are reduced due to the decrease in the weight of a vehicle and the prevention of power loss, environment-friendliness is ensured and no oil leakage occurs because no oil is used, lightness in the weight of the vehicle is accomplished and assemblability is improved due to the decrease in the number of parts, steering performance is improved due to the precise control of steering force depending upon vehicle speed and the improvement in the high speed running stability. For this reason, recently, the motor-driven power steering system has been increasingly used.

In order to accommodate this trend, research has been actively conducted to develop optimal factors capable of decreasing the weight and the manufacturing cost of a motor-driven power steering system.

The above information disclosed in this Background section is only for enhancement of understanding of the background of the invention and therefore it may contain information that does not form the prior art that is already known in this country to a person of ordinary skill in the art.

### SUMMARY

Accordingly, the present invention has been made as a result of the research, and an object of the present invention is to provide a method for controlling a motor-driven power steering system, which can effectively control an increase in motor speed and a resulting increase in inertia moment, caused when the gear ratio between the worm and the worm wheel constituting a reduction gear box in a motor-driven power steering system increases, thereby contributing to a reduction in the manufacturing cost due to the increase in the gear ratio.

In order to achieve the above object, according to one aspect of the present invention, there is provided a method for controlling a motor-driven power steering system, in which a target torque value of a motor is calculated by receiving a steering torque, a steering angle, a steering angular velocity and a vehicle speed and conducting torque boost control, returning force control and damping control, current motor current is sensed, proportional integral control is conducted for the current motor current, a pulse width modulation signal for compensating for over/under voltage in comparison with the target torque value is generated, and a final motor torque is controlled, wherein the proportional integral control is added with motor speed-responsive control by a proportional constant (α) that varies depending upon a motor speed, which is sensed in real time.

Preferably, the proportional constant (α) has a value that is inversely proportional to the motor speed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a conventional motor-driven power steering system;

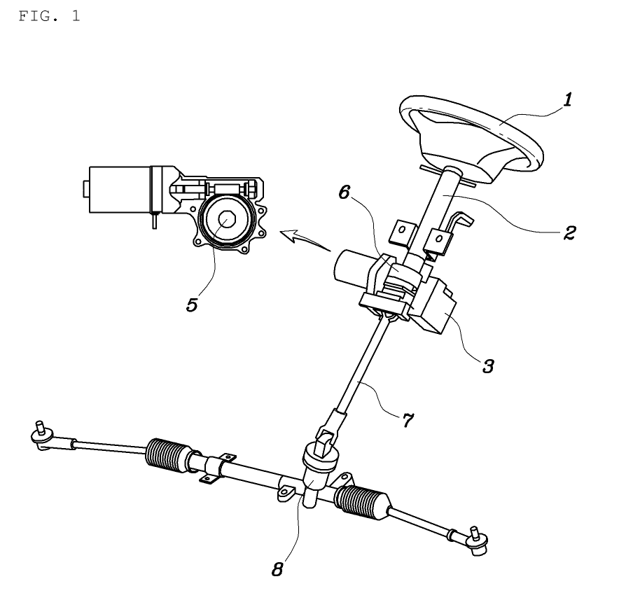

FIG. 2 is a flow chart illustrating a method for controlling a motor-driven power steering system in accordance with an embodiment of the present invention;

FIG. 3 is a control block diagram of the motor-driven power steering system of FIG. 2; and

FIG. 4 is a view illustrating one example of motor speed-responsive control according to the present invention.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

In a motor-driven power steering system, if the gear ratio between the worm and the worm wheel constituting a reduction gear box for a motor is increased, the rated actuation point of the motor is changed, resulting in a decrease in the desired torque of the motor.

For example, a rated torque of 3.7 N·m is required to generate an output of 400 W in a certain gear ratio between the worm and the worm wheel. If the gear ratio between the worm and the worm wheel is increased by 1.4 times, the rated torque required to generate the same output becomes 2.4 N·m. Because this decrease in the rated torque can cause a decrease in the weight and the size of a motor under the same output generating condition, it is possible to manufacture a motor-driven power steering system at a reduced cost.

On the other hand, the increase in the gear ratio between the worm and the worm wheel results in an increase in a motor speed. For instance, if the gear ratio between the worm and the worm wheel is increased by 1.4 times, the motor speed increases from 1,050 rpm to 1,500 rpm. The increase in the motor speed causes an increase in the inertia moment of the motor, thereby reducing the responsiveness of steering control.

According to the present invention, a speed-responsive control logic is provided to solve the above-described problem associated with the increase in motor speed.

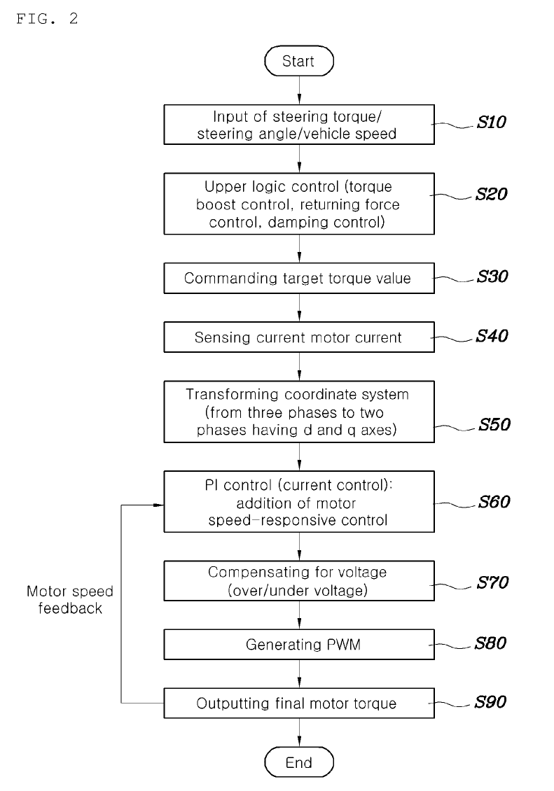

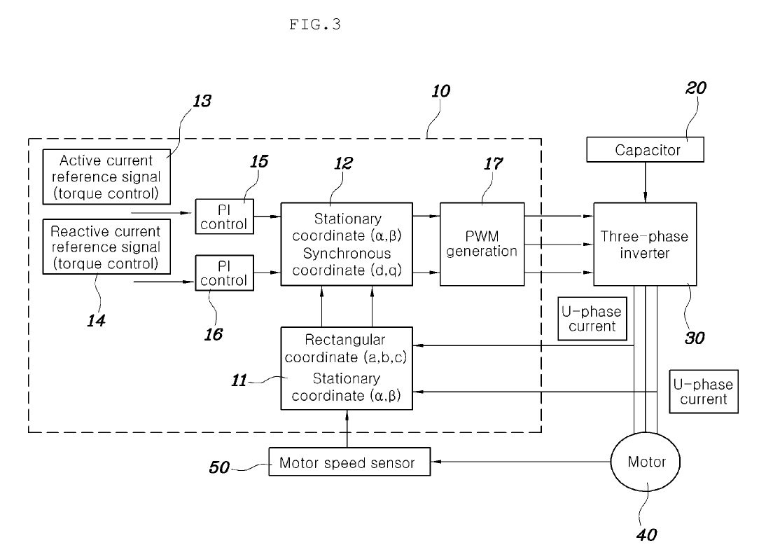

FIG. 2 is a flow chart illustrating a method for controlling a motor-driven power steering system in accordance with an embodiment of the present invention, and FIG. 3 is a block diagram thereof. For reference, in FIG. 3, the configuration illustrated in the controller 10 designates a software logic, and the configuration illustrated outside the controller 10 designates hardware components.

The method for controlling a motor-driven power steering system generally comprises system control steps (S10 through S30) and actuator control steps (S40 through S90).

First, describing the system control steps, a steering torque, a steering angle, a steering angular velocity and a current vehicle speed, which are generated as a driver rotates a steering wheel, are sensed by a torque sensor, a steering angle sensor, a steering angular velocity sensor and a vehicle speed sensor, which are installed in the steering system, and are transmitted to a controller 10 (S10).

In the controller 10, a target torque value is calculated through conducting torque boost control, returning force control and damping control, using the transmitted steering torque, steering angle, steering angular velocity and vehicle speed data (S20 and S30). The torque boost control is conducted to control the output voltage depending upon the steering torque generated by the driver. The returning force control is conducted to control the force for returning the manipulated steering wheel to the original center position. The returning force acts in the direction opposite the steering force. The damping control is conducted to control steering reaction force or the force acting in correspondence with the returning force to thereby improve the driver's steering feel. Damping force acts in the same direction as the steering force.

Through conducting the torque boost control, the returning force control and the damping control, the target torque value to be generated by a motor depending upon the degree to which the steering wheel is manipulated by the driver is calculated and outputted.

Control of the motor as a real actuator is conducted in order to generate the target torque value outputted through the system control steps, as described below.

The current applied from a capacitor 20 is transmitted to a motor 40 through a three-phase inverter 30, and the controller 10 senses the three-phase current (on U, V and W axes) that is currently applied to the motor 40 (S40). The sensed three-phase current is converted into two phases (on d and q axes) to be easily controlled through subsequent PI (proportional integral) control (S50). In detail, the rectangular coordinate (a,b,c) of the sensed three-phase current is converted into a stationary coordinate (α,β), which in turn is converted into a synchronous coordinate (d,q) (see the reference numerals 11 and 12 in FIG. 3).

Next, the proportional integral control (see the reference numerals 15 and 16 in FIG. 3) as current control is implemented using the converted two-phase current (S60). In detail, using the converted two-phase current, torque control (see the reference numeral 13 in FIG. 3) (on the q axis) in response to an active current reference signal and torque control (see the reference numeral 14 in FIG. 3) (on the d axis) in response to a reactive current reference signal are respectively implemented. Thereafter, in comparison with the target torque value calculated through the system control steps, an over/under amount in the voltage currently applied to the motor is calculated, and a PWM (pulse width modulation) signal (see the reference numeral 17 in FIG. 3) for compensating for the over/under amount is generated (S70 and S80). The PWM signal is decreased in pulse width when the source power has an over voltage and is increased in a pulse width when the source power has an under voltage. When the output of the controller 10 is transmitted to the motor by way of the signal generated in the form of this pulse, a final motor torque is generated (S90).

As shown in FIG. 2, a control logic is performed, in which the speed of the motor rotated by the final motor torque outputted from the step S90 is sensed in real time by a motor speed sensor 50 and is fed back to the step S60 as the proportional integral control step such that the control depending upon the motor speed (referred to as “motor speed-responsive control”) is performed, thereby preventing the problem of the decrease in steering control responsiveness decrease due to the increase in inertia moment.

This motor speed-responsive control can be designed in various ways depending upon the specification of a motor-driven power steering system by setting an appropriate proportional constant (α) which varies depending upon a motor speed, calculating a control value from a proportional expression using the proportional constant (α), and carrying out control operation so as to reduce or minimize the influence by the inertia moment.

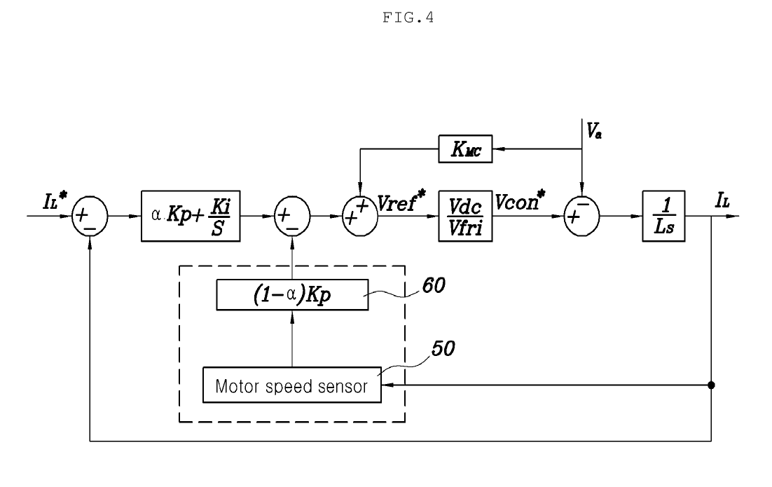

FIG. 4 illustrates one example of motor speed-responsive control according to the present invention. Here, I_{L}* designates a torque reference signal, and I_{L} designates a finally outputted load current. Further, Vdc is a current input to the controller, Vcon* is a control output of the controller, Vref* is a voltage reference signal inputted to the controller, and Vfri is the peak value of a triangular wave voltage in the controller. The circles including operation symbols indicate operators. For example, if + and + are included in a circle, it means that two values are to be added.

In FIG. 4, the torque reference signal I_{L}*, calculated through the system control steps, is calculated as load current I_{L} to be finally outputted to the motor, through several operation stages. The final load current I_{L} is sensed through the step S40 of FIG. 2 and is fed back to be operated with the torque reference signal I_{L}*. At this time, according to the present invention, a motor speed sensor 50 is fed back with the final load current I_{L} and senses a motor speed in real time, and a motor speed-responsive control logic, in which a proportional expression 60 depending upon the motor speed is included, is constructed. In the proportional expression 60, K_{P} is a proportional coefficient that is determined depending upon a system specification, a control range, etc.

The following Table 1 gives the values of a proportional constant (α) that varies depending upon a motor speed, in the motor speed-responsive control logic constructed as shown in FIG. 4.

TABLE 1

| Motor speed (rpm) | Proportional constant (α) |
|---|---|
| 0~1,000 | 1 |
| 1,000~1,500 | 0.8 |
| 1,500~2,000 | 0.6 |
| 2,000~2,500 | 0.4 |
| 2,500~3,000 | 0.2 |
| Over 3,000 | 0 |

Referring to Table 1, the proportional constant (α) constructing the motor speed-responsive control logic has a decreased value as the motor speed increases. In other words, the proportional constant (α) has a value that is inversely proportional to the motor speed. As a consequence, the more the motor speed increases, the less the proportional constant (α) is. As a result, the entire control value to be fed back also increases by the term (1-α)K_{P} as the proportional expression 60 shown in FIG. 4. Accordingly, in the event that the inertia moment increases as the motor speed increases, a control value is also increased to reduce the deterioration of steering responsiveness due to the increase in the inertia moment.

As is apparent from the above description, the method for controlling a motor-driven power steering system according to the present invention confers advantages in that it is possible to effectively control the increase in motor speed and the resultant increase in inertia moment, caused when increasing the gear ratio between the worm and the worm wheel constituting a reduction gear box in a motor-driven power steering system. As a consequence, since the manufacturing cost can be decreased due to the increase in the gear ratio, a motor-driven power steering system can be realized at a reduced cost.

Although preferred embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A method for controlling a motor-driven power steering system, in which a target torque value of a motor is calculated by receiving a steering torque, a steering angle, a steering angular velocity and a vehicle speed and conducting torque boost control, returning force control and damping control, a current motor current is sensed, proportional integral control is conducted for the current motor current, a pulse width modulation signal for compensating for an over/under voltage in comparison with the target torque value is generated, and a final motor torque is controlled, wherein the proportional integral control is added with motor speed-responsive control by a proportional constant (α) that varies depending upon a motor speed, which is sensed in real time.

2. The method according to claim 1, wherein the proportional constant (α) has a value that is inversely proportional to the motor speed.
